(19) United States
(12) Patent Application Publication
(10) Pub. No.: US 2007/0168573 A1
(43) Pub. Date: Jul. 19, 2007

(54) UPDATING METHOD OF USB DEVICE

(75) Inventors: Hee Gyum KIM, Seongnam-si (KR); Sun Woo PARK, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Youngdungpo-gu, Seoul (KR)

(21) Appl. No.: 11/457,489

(22) Filed: Jul. 14, 2006

(30) Foreign Application Priority Data
Nov. 22, 2005 (KR) 10-2005-0111528

(51) Int. Cl. G06F 3/00

(52) U.S. Cl. 710/10

(57) ABSTRACT

A method of updating a plurality of USB devices is provided. Firmwares of the USB devices are updated by discriminating the USB devices using their unique device interface IDs. Accordingly, a plurality of USB devices of the same product family can be discriminated using device interface IDs and thus the firmwares of the USB devices can be updated at the same time.

### BACKGROUND OF THE INVENTION

1. Field of the Invention

The present invention relates to a firmware update of a universal serial bus (USB) communicating through a USB bus, and more particularly, to an updating method of a USB device, capable of simultaneously updating firmwares of USB devices in a state in which a plurality of USB devices of the same product family are connected.

2. Description of the Related Art

Universal serial bus (USB) is a kind of serial port and a kind of plug-and-play interface between a computer and peripheral devices, such as audio player, joystick, keyboard, telephone, scanner, and printer.

A principle of the USB is equal to that of the serial port. However, compared with the serial port, the USB is faster and is more convenient to connection with another device. Since the USB supports 12-Mbps data transfer rate, its speed is sufficient even when a lot of peripheral devices are connected. Also, the UBS can chain up to 127 peripheral devices.

USB 2.0 can support data transfer rate up to 480 Mbps.

Also, even when the USB is connected while using a computer, it can be recognized and an additional power for peripheral devices is not required.

According to the related art, a computer recognizes a USB device by identifying Vendor ID (VID) and Product ID (PID) of the USB device connected thereto.

In the above method, when the USB device is connected, the computer reads VID and PID from a scripter of the USB device and loads a corresponding driver. In this manner, the computer is ready to use the USB device. VID is a unique identifier of vendor, and PID is a unique identifier of product.

When several same USB devices are connected to the computer, the conventional recognizing method normally recognizes only one product. Therefore, when updating firmware, only one product is processed.

FIG. 1 is a picture of a control panel in a conventional firmware updating method of a USB device.

Referring to FIG. 1, even when less than 127 same USB devices 100-1 to 100-N are connected to a computer, firmwares for each of the USB devices 100-1 to 100-N are executed one by one.

Accordingly, assuming that it takes 132 seconds to update a firmware, it takes 132×N seconds to update firmwares of N number of USB devices of the same product family. Consequently, in spite of the advantage that can recognize several USB devices, a lot of time and effort are necessary.

### SUMMARY OF THE INVENTION

Accordingly, the present invention is directed to an updating method of USB device that substantially obviates one or more problems due to limitations and disadvantages of the related art.

An object of the present invention is to provide an updating method of USB device, capable of simultaneously updating firmwares of USB devices by using interface ID to discriminate a plurality of USB devices of the same family.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an updating method of a USB device, including: recognizing an access of N number of USB devices at a host performing USB communication with the USB devices, and identifying unique device interface IDs assigned to each of the USB devices; checking the unique device interface IDs of the USB devices at the host, executing a program to update operation programs of the USB devices, and creating a device handle for controlling the at least one USB device; creating N number of lower control windows for performing separate updates of the USB devices with reference to the device handle; and separately performing the updates of the plurality of USB devices according to an external control signal received through the N number of the control windows.

In another aspect of the present invention, there is provided a recording medium storing a program, the program having a function of updating a USB device, the program including: a first function of recognizing an access of N number of USB devices at a host performing USB communication with the USB devices, and identifying unique device interface IDs assigned to each of the USB devices; a second function of checking the unique device interface IDs of the USB devices at the host, executing a program to update operation programs of the USB devices, and creating a device handle for controlling the at least one USB device; a third function of creating N number of lower control windows for performing separate updates of the USB devices with reference to the device handle; and a fourth function of separately performing the updates of the plurality of USB devices according to an external control signal received through the N number of the control windows.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a picture of a control panel in a conventional firmware updating method of a USB device;

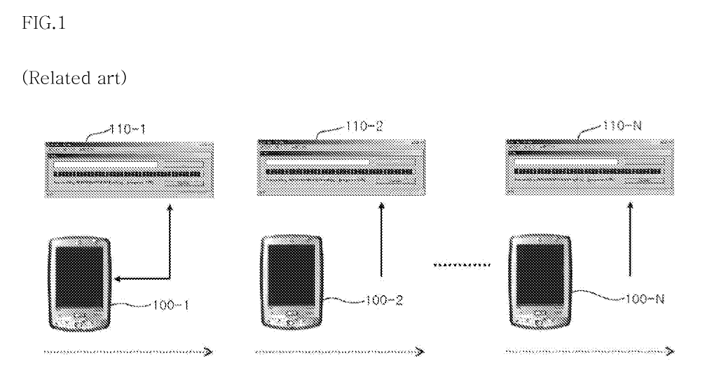

FIG. 2 is a flowchart diagram illustrating a firmware updating method of a USB device according to an embodiment of the present invention; and

FIG. 3 is a picture of a control panel in the firmware updating method according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

An updating method of USB device according to the present invention enables USB devices to be recognized using device interface ID. Therefore, when a plurality of USB devices of the same product family are connected, firmwares can be updated at the same time. Hereinafter, the updating method of USB device according to the present invention will be described in detail with reference to the accompanying drawings.

However, a detailed description about well-known parts will be omitted.

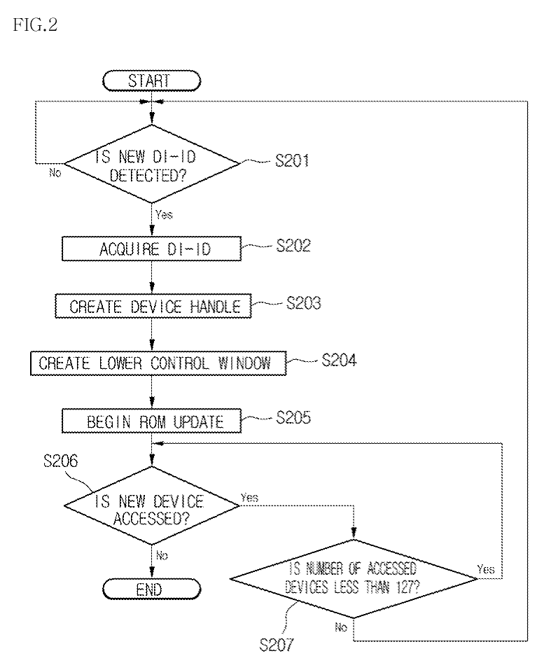

FIG. 2 is a flowchart diagram illustrating a firmware updating method of USB device according to an embodiment of the present invention.

Referring to FIG. 2, when an USB device performing a USB communication accesses a host computer, the computer detects the access of a new USB device. The computer detects a Device Interface-ID (DI-ID) of the USB device and acquires it (S201, S202)

Even USB devices that are the same models of the same manufacturer have different DI-IDs.

The computer that has acquired the DI-ID can manually or automatically execute program applied according to the corresponding USB device. Also, firmware update can be executed manually or automatically.

For this purpose, the computer generates a device handle for executing the update of the USB device by the firmware update program of the USB device (S203), and creates a lower control window for a firmware update of the USB device in the executed program (S204). Then, the computer begins a ROM update including firmware (S205).

The program for the update is a parent window and the lower control window is a child window. The lower control window for the update operates with reference to the handle value acquired by the program for the firmware update.

After creating the lower control window, the user selects a ROM file or firmware file through a browser button input. Then, a selection of an update execution button starts the update.

At this point, while the USB device is executing the ROM update, if a USB device of the same product family or other product family is newly accessed (S206), it is checked whether the number of all USB devices currently connected exceeds 127 (S207). DI-DI is acquired in operations S201, and an operation of executing the ROM update is separately performed on the newly accessed USB device.

That is, since up to 127 USB devices can be connected to the computer, when more than 127 USB devices are connected, they can be no more recognized and thus the operation on the corresponding USB device is not executed.

In addition, DI-DI for the newly accessed USB device is acquired, a device handle is generated to create a control window for the ROM update, and then the update is executed. Therefore, an additional ROM update control window is created for each of the USB devices. Even when the USB devices belong to the same product family, the ROM update is separately performed.

Accordingly, when the ROM update is executed in a state in which N number of USB devices of the same product family is connected, N number of lower control windows is created and ROM updates are separately executed.

Even though it takes 132 seconds to update one USB device, time taken to update N number of USB devices may be different depending on each starting time point. However, since the same ROM updates can be executed at the same time, the update of N number of the USB devices can be completed in 132 seconds.

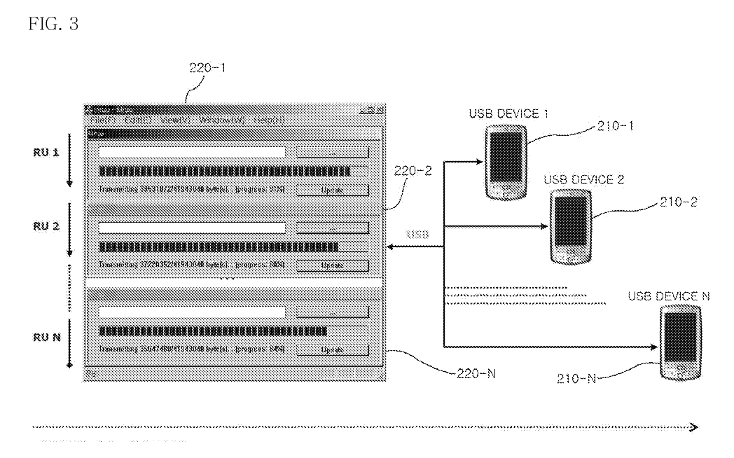

FIG. 3 is a picture of a control panel in the firmware updating method of the USB according to an embodiment of the present invention.

Referring to FIG. 3, when N number of USB devices 210-1 to 210-N is connected, an update program 220 of a USB device is executed, and control windows 220-1 to 220-N for each of the USB devices are created and then the respective updates are performed.

Meanwhile, in a protocol for update between the computer and the USB device, if the computer acting as a host transmits an update start command message RU_CMD to the USB together with an update file, the USB device sends a corresponding response ACK or NACK.

The computer transmits the update file to the USB device according to the response of the USB device and performs the update. The USB device sends a response message to the computer with respect to the incoming data.

If a data transmission for the update is finished, the computer sends an update start command RU_COM, and the USB device sends a response to the computer. Then, the update is executed using the received data.

At this point, N represents integers of less than 127. Even the USB devices of the same product family have different DI-DIs. Using this, the respective USB devices are discriminated.

According to the present invention, the USB devices are discriminated using their unique device interface Ids and thus the firmwares can be simultaneously updated, thereby providing the efficient update. It is apparent to those skilled in the art that other embodiments can be provided through selections of components within the scope of the present invention.

Accordingly, by discriminating the USB devices using their device interface IDs, the update can be executed simultaneously and separately, thereby efficiently managing the USB devices and reducing the update time.

It will be apparent to those skilled in the art that various modifications and variations can be made in the present invention. Thus, it is intended that the present invention covers the modifications and variations of this invention provided they come within the scope of the appended claims and their equivalent.

What is claimed is:

1. An updating method of a USB (universal serial bus) device, comprising:
recognizing an access of N number of USB devices at a host performing USB communication with the USB devices, and identifying unique device interface IDs assigned to each of the USB devices;
checking the unique device interface IDs of the USB devices at the host, executing a program to update operation programs of the USB devices, and creating a device handle for controlling the at least one USB device;
creating N number of lower control windows for performing separate updates of the USB devices with reference to the device handle; and
separately performing the updates of the plurality of USB devices according to an external control signal received through the N number of the control windows.

2. The updating method according to claim 1, wherein N is integers that are equal to or greater than 1 and less than 127.

3. The updating method according to claim 1, further comprising:
recognizing an access of a new (N+1)th USB device;
determining whether or not the number of (N+1) is less than 127;
if the number of (N+1) is less than 127, acquiring a device interface ID of the new (N+1)th USB device and creating a device handle for controlling the new (N+1)th USB device; and
performing an update by creating an (N+1)th lower control window for updating an operation program of the (N+1)th USB device with reference to a generated handling value.

4. The updating method according to claim 3, wherein the number of (N+1) exceeds 127, the new USB device is not recognized.

5. The updating method according to claim 1, wherein the N number of the USB devices belongs to the same product family.

6. The updating method according to claim 1, wherein when a number of USB devices among the N number of the USB devices belongs to the same product family and b number of USB devices among the N number of the USB devices belongs to the same product family (where N=a+b), unique update programs are separately executed according to the respective product families, and a number of lower control windows and b number of lower control windows are separately created in the respective programs, thereby enabling the update.

7. The updating method according to claim 1, wherein the updating of the operation program includes:
sending an updating start command message (RU_CMD) from the host to the corresponding USB device and receiving a response from the corresponding USB device;
transmitting operation program data from the host to the USB device;
if the data transmission from the host to the USB device is finished, sending an update start command message to the USB device and executing the corresponding update.

8. The updating method according to claim 1, wherein the updating operation program is ROM data for operation of the USB device.

9. The updating method according to claim 1, wherein the updating operation program is firmware file of the USB device.

10. The updating method according to claim 1, wherein the acquiring of the unique device interface ID of the USB device includes:
accessing the USB device to the host;
assigning a unique device interface ID of the accessed USB device at the host; and
re-sending the assigned unique device interface ID from the USB device to the host according to a request of the host.

11. A recording medium storing a program, the program having a function of updating a USB (universal serial bus) device, the program comprising:
a first function of recognizing an access of N number of USB devices at a host performing USB communication with the USB devices, and identifying unique device interface IDs assigned to each of the USB devices;
a second function of checking the unique device interface IDs of the USB devices at the host, executing a program to update operation programs of the USB devices, and creating a device handle for controlling the at least one USB device;
a third function of creating N number of lower control windows for performing separate updates of the USB devices with reference to the device handle; and
a fourth function of separately performing the updates of the plurality of USB devices according to an external control signal received through the N number of the control windows.
